(19) United States
(12) Patent Application Publication
(10) Pub. No.: US 2005/0008812 A1
(43) Pub. Date: Jan. 13, 2005

(54) Copy protection of optical discs

(76) Inventors: Mark Dominic Jackson, Chineham, Basingstoke, Hants (GB); Richard AA Heylen, Leeds (GB); Barach Sollish, Emmanuel (IL)

Correspondence Address: PATENT DEPARTMENT;MACROVISION CORPORATION, 2830 DE LA CRUZ BLVD., SANTA CLARA, CA, 95050, US

(21) Appl. No.: 10/492,925

(22) PCT Filed: Oct. 14, 2002
(86) PCT No.: PCT/GB02/04629

(30) Foreign Application Priority Data
Oct. 15, 2001 (GB) 0124723.8

(51) Int. Cl. B32B 3/02

(52) U.S. Cl. 428/64.4

(57) ABSTRACT

In a method of copy protecting an optical disc carrying information and control data, access to selected information is controlled by removing, corrupting, or otherwise rendering incorrect or inaccurate control data describing the selected information. For example, where an optical disc carries both a first, audio, session (30) and a second, data, session (40), the audio session (30) can be effectively hidden from a data reader by including control data in the data session which incorrectly identifies audio files as data files. In addition, or as an alternative, information in the files, directories, or descriptors of the volume of information making up a data session may be removed, corrupted or rendered incorrect to similarly prevent a data reader accessing the information.

The present invention relates to a method of controlling access to data on an optical disc, and to an optical disc having means thereon to control access to its data.

Digital audio compact discs (CD-DA) which carry music or other audio can be played not only on CD players but can also be played on more sophisticated apparatus, such as CD-ROM drives which can also read the data on the disc. This means, for example, that the data on a CD-DA acquired by a user may be read into a PC by way of its ROM drive and thus copied onto another disc or other recording medium. The increasing availability of recorders able to write to CDs is therefore an enormous threat to the music industry.

WO 00/74053 proposes copy protecting audio data on a digital audio compact disc by rendering control data encoded onto the disc incorrect and/or inaccurate. The incorrect data encoded onto the CD is either inaccessible to, or not generally used by, a CD-DA player. Therefore, a legitimate audio CD bought by a user can be played normally on a compact disc music player. However, the incorrect data renders protected audio data on the CD unplayable by a CD-ROM drive.

However, as the protected audio data is rendered unplayable on a CD-ROM drive, the user is also prevented from using the CD-ROM drive legitimately simply to play the music or other audio on the disc.

It clearly would be advantageous to provide a method of copy protection for optical discs which, whilst preventing the production of usable copy discs, would not prevent or degrade, for example, the playing of legitimate audio discs on all players having the functionality to play audio discs. Examples of such copy protection methods are described in WO 01/61695 and in WO 01/61696.

The present invention seeks to provide alternative copy protection methods.

According to a first aspect of the present invention there is provided a method of controlling access to information on an optical disc carrying information and control data, the control data being arranged to facilitate access to the information, wherein access to selected information is controlled by removing, corrupting, rendering incorrect and/or inaccurate, or otherwise interfering with control data describing said selected information.

Embodiments of the method of the present invention may be used to copy protect the information on an optical disc, or selections of that information, and/or the interference applied to the control data may be arranged to enable access to any information on a disc only where that access is licensed.

In a preferred embodiment of the method of the invention, the information is arranged on the optical disc in at least two separate sessions, respective control data being associated with each session, access to the selected information in a first session being controlled by interfering with control data which is in a second session and which describes said selected information.

With an embodiment of the invention for use, for example, to copy protect a CD-DA, the incorrect control data encoded onto the CD would either be ignored or would otherwise not generally have an effect on the playing of the audio data on the disc. Therefore, a legitimate audio CD bought by a user can be played normally on any player able to play audio data. However, where a copy of the copy protected CD is to be made by reading the audio data, reading or extraction of the audio data is prevented or controlled.

In the specification the term “audio player” is used to refer to players and drives arranged or controlled to play the audio data on a digital audio compact disc. Such players will include, therefore, commercially available CD music players which function solely to play the music or other audio on the CD. It is required that the incorrect data encoded onto the CD does not generally impinge on, or affect the normal operation of, such an “audio player”.

In the specification, the term “data reader” is used to refer to all players and drives arranged or controlled to read the data on the disc, for example, by extracting or otherwise accessing the data on the disc. Such players will include, therefore, CD-ROM and CD-I drives when configured or controlled to read or extract data from disc. In this respect, it is required to enable a CD-ROM drive, for example, to play a legitimate CD-DA, but to prevent such a CD-ROM drive from being used to make a usable copy of the disc.

As is made clear above, the present invention is generally applicable to the control of access to information on an optical disc. Obviously, the nature of the information and the nature of the control data will change in accordance with the format of the optical disc concerned. For a CD-DA, for example, the information will generally be audio data only, whereas in modern CD-ROM formats, the information may include not only numerical written and audio data, but also video data, graphics data, programs and computer data and data of other natures.

The embodiments of the invention as set out above generally require that control data describing selected information be removed, corrupted, rendered incorrect and/or inaccurate, or be otherwise interfered with. The control data to which the interference is applied may, for example, be descriptive data providing a description as to the nature of the information, and/or as to the location of the information on the disc, and/or as to the structure of the information on the disc, and/or as to how the information should be accessed. This latter, access controlling, descriptive data, for example, may contain information as to coding schemes, data timing, or the existence of sync and other control words.

The control data may, for example, be provided in the Lead-In to a data session, for example, in the Table of Contents (TOC), and/or may be included in, or constituted by navigation and/or timing data generally.

Additionally and/or alternatively, the control data to which the interference is applied is provided in one or more descriptors for the information. For example, said control data may be in a primary volume descriptor. Additionally, and/or alternatively, said control data may be in a secondary volume descriptor.

In one embodiment, said control data may be in one or more directories. For example, the control data to which interference is applied may be address information.

In a preferred embodiment, in which the control data is removed, the removed control data may be a primary volume descriptor.

In an embodiment in which the control data is corrupted, the corruption may be by replacing values of the control data with different values. For example, the replacement values may be all zeros or random numbers. Alternatively, the replacement values may be chosen to cause DSV problems, for example, as described in PCT/GB01/03364.

In one embodiment, the control data is encrypted or scrambled. Where the data reader or its owner is licensed to have access to the information, for example, the data reader may be provided with, or able to access, suitable decrypting or unscrambling software so that it is able to access correct values for the control data and thereby access the information.

In a preferred embodiment, the control data is rendered incorrect and/or inaccurate.

For example, the nature of the information, and/or the location of the information, and/or the structure of the information, and/or addresses for the information are interfered with to thereby render the control data incorrect and/or inaccurate.

According to a second aspect of the present invention there is provided a method of controlling access to information on an optical disc carrying information and control data, the control data being arranged to facilitate access to the information, wherein the information is arranged on the optical disc in at least two separate sessions, respective control data being associated with each session, and wherein access to the information in a first session is controlled by incorporating incorrect and/or inaccurate values in control data in a second session.

With the use of multiple sessions, according to embodiments of a method of the invention, it is possible to effectively hide an individual session. For example, where the information in a first session is audio data, that audio data may be rendered unreadable to a data reader by including in a second data session control data which incorrectly identifies audio files as data files.

Additionally and/or alternatively, the control data incorporating incorrect and/or inaccurate values may be arranged to render the optical disc unplayable unless appropriate means are provided to correct the incorrect and/or inaccurate values.

In a preferred embodiment of this second aspect of the invention, the incorrect and/or inaccurate values are incorporated in control data in the second session which describes the information in the first session to which access is to be controlled.

The present invention also extends to an optical disc carrying means to control access to information thereon, the optical disc carrying information and control data, the control data being arranged to facilitate access to the information, wherein to control access to selected information control data describing said selected information has been removed, corrupted, rendered incorrect and/or inaccurate or otherwise interfered with.

Embodiments of optical discs of the present invention may be arranged such that the information thereon is copy protected, and/or so that access to selected information is only available where the access is licensed.

In a preferred embodiment of an optical disc of the invention, the information is arranged on the disc in at least two separate sessions, respective control data being associated with each session, and access to the selected information in a first session being controlled by providing that control data, which is in a second session, and which describes said selected information, has been interfered with.

With embodiments of the invention for use, for example, where the optical disc is a CD-DA, such that the information thereon is audio data, the control data which has been interfered with, and which is encoded onto the CD, would either be ignored or would otherwise not generally have an effect on the playing of the audio data on the disc.

The control data on the optical disc to which interference has been applied may, for example, be descriptive data which provides a description as to the nature of the information, and/or as to the location of the information on the disc, and/or as to the data structure of the information on the disc, and/or as to how the information is to be accessed. This latter, access controlling, descriptive data, for example, may contain information as to coding schemes, data timing, or the existence of sync pulses and other control words.

The control data to which interference has been applied may be, for example, provided in the Lead-In to a data session, for example, in the Table of Contents (TOC), and/or may be included in, or constituted by other navigation and/or timing data generally.

In an embodiment, the control data to which interference has been applied is provided in one or more descriptors for the information. For example, the control data may be in a primary volume descriptor. Additionally and/or alternatively, the control data may be in a secondary volume descriptor. In addition, and/or as an alternative, the control data may be in one or more directories.

Additionally, and/or alternatively, the control data to which interference has been applied may be address information.

Additionally, and/or alternatively, the control data to which interference has been applied may be navigation and/or timing data.

In an embodiment in which the control data has been removed, the removed control data may have been a primary volume descriptor.

In an additional and/or alternative embodiment in which the control data has been corrupted, the control data may have been corrupted by replacing values thereof with different values. For example, the replacement values may be all zeros or random numbers. Alternatively, the replacement values may have been chosen to cause DSV problems, for example, as described in PCT/GB01/03364.

In a preferred embodiment, the values of the control data may be encrypted or scrambled.

In an embodiment where the control data has been rendered incorrect and/or inaccurate, the nature of the information, and/or the location of the information, and/or the structure of the information, and/or addresses for the information may have been interfered with to thereby render the control data incorrect and/or inaccurate.

The present invention additionally extends to an optical disc carrying means to control access to information thereon, the optical disc carrying information and control data, the control data being arranged to facilitate access to the information, wherein the information is arranged on the disc in at least two separate sessions, respective control data being associated with each session, and wherein access to the information in a first session is controlled by control data in a second session, into which control data incorrect and/or inaccurate values have been incorporated.

In an embodiment of an optical disc of the invention, the correct and/or inaccurate values are incorporated in control data in the second session, which control data describes the information in the first session to which access is to be controlled.

According to a further aspect of the present invention there is provided a volume of information for application to a data carrying disc, the information being arranged in files, the attributes and locations of the files being recorded in directories, and the volume being incorporated by the files and directories and by descriptors containing descriptive information about the volume, directories and files, the volume of information having been altered to control or prevent access to selected information, the alteration being the removal or corruption of one or more descriptors, and/or the rendering of one or more of the descriptors incorrect and/or inaccurate.

A volume of information of an embodiment of the invention may be encoded and applied, for example, to a CD-DA, to provide copy protection for the information.

In an embodiment, a primary volume descriptor may be corrupted or removed and/or the data therein is rendered incorrect or inaccurate. Additionally and/or alternatively, a secondary volume descriptor may be corrupted or removed and/or the data therein is rendered incorrect or inaccurate. Additionally and/or alternatively, one or more directories may be corrupted or removed and/or the data therein is rendered incorrect or inaccurate.

In an additional and/or alternative embodiment, address information is corrupted or removed and/or the data therein is rendered incorrect or inaccurate.

In a preferred embodiment, a primary volume descriptor is removed. Additionally and/or alternatively, a pointer of a primary volume descriptor to a directory may be removed. The directories may be generally arranged in a hierarchical structure having a root directory and other sub-directories, and the removed pointer may have accessed the root directory.

Embodiments of the present invention will hereinafter be described, by way of example, with reference to the accompanying drawings, in which:—

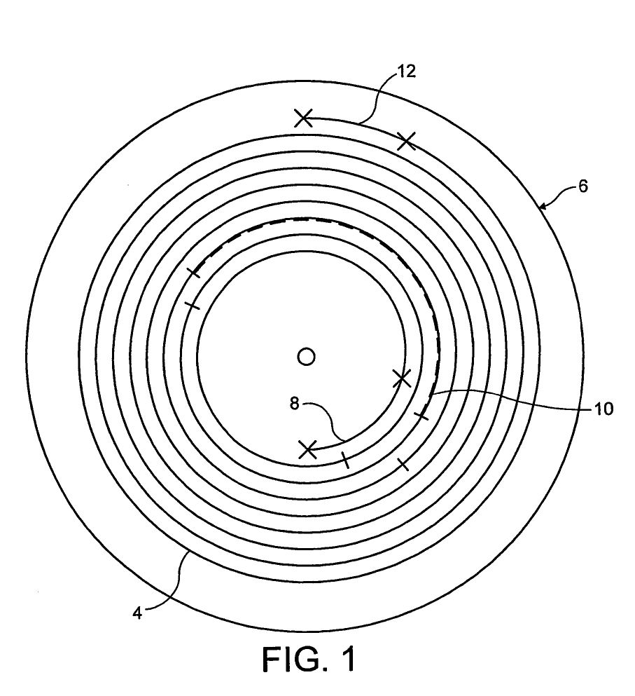

FIG. 1 shows schematically a compact disc showing the spiral data track,

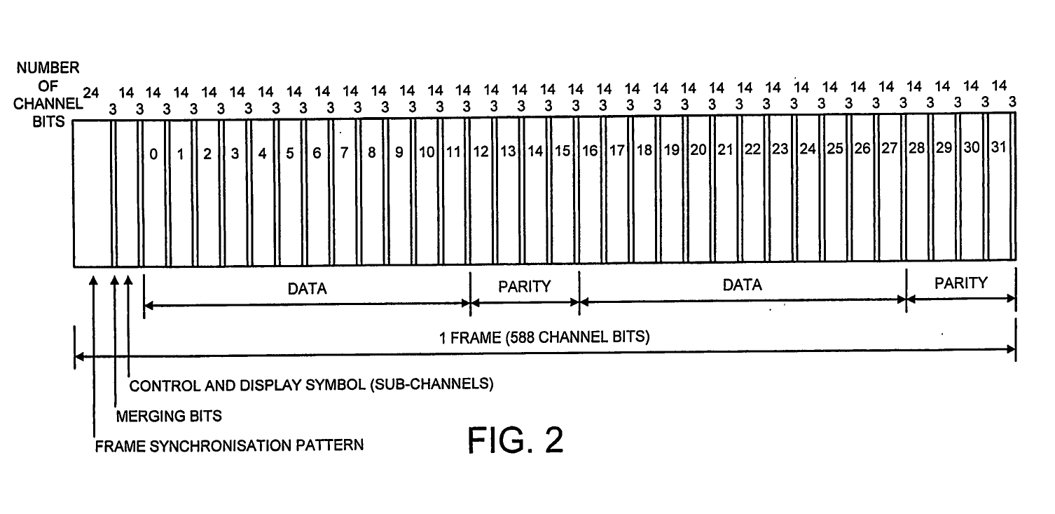

FIG. 2 shows the structure of a frame of data encoded on a CD,

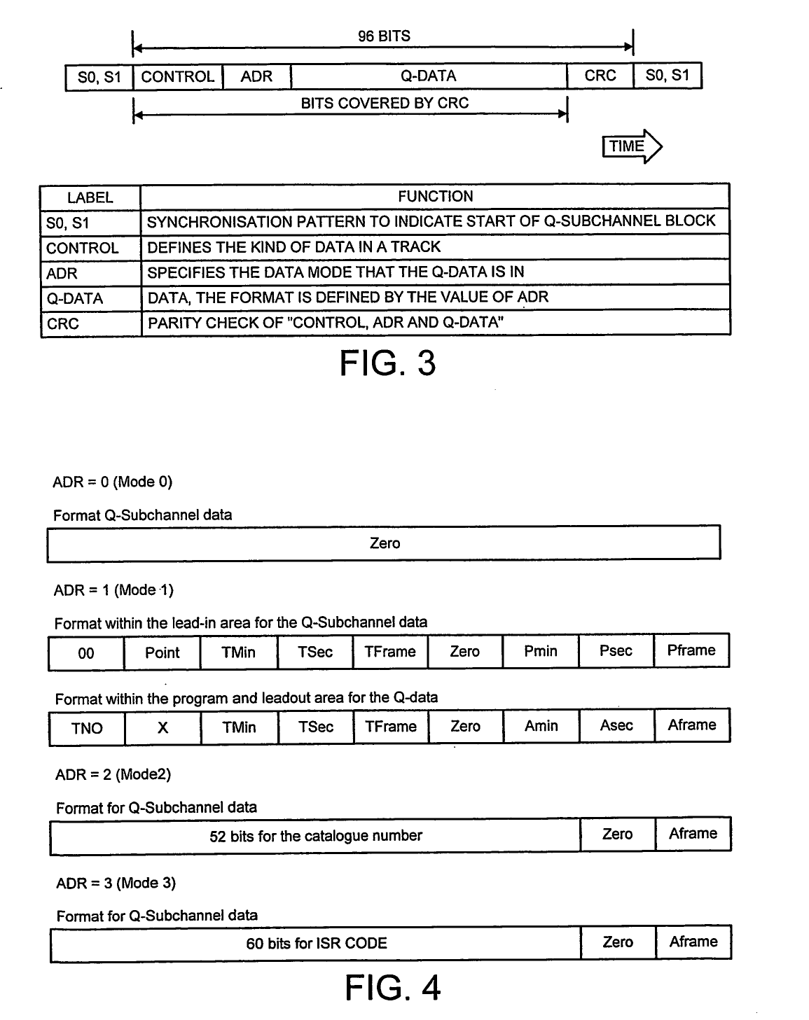

FIG. 3 illustrates the general data format of the Q-subchannel,

FIG. 4 shows the format of the data for the Q-subchannel according to mode,

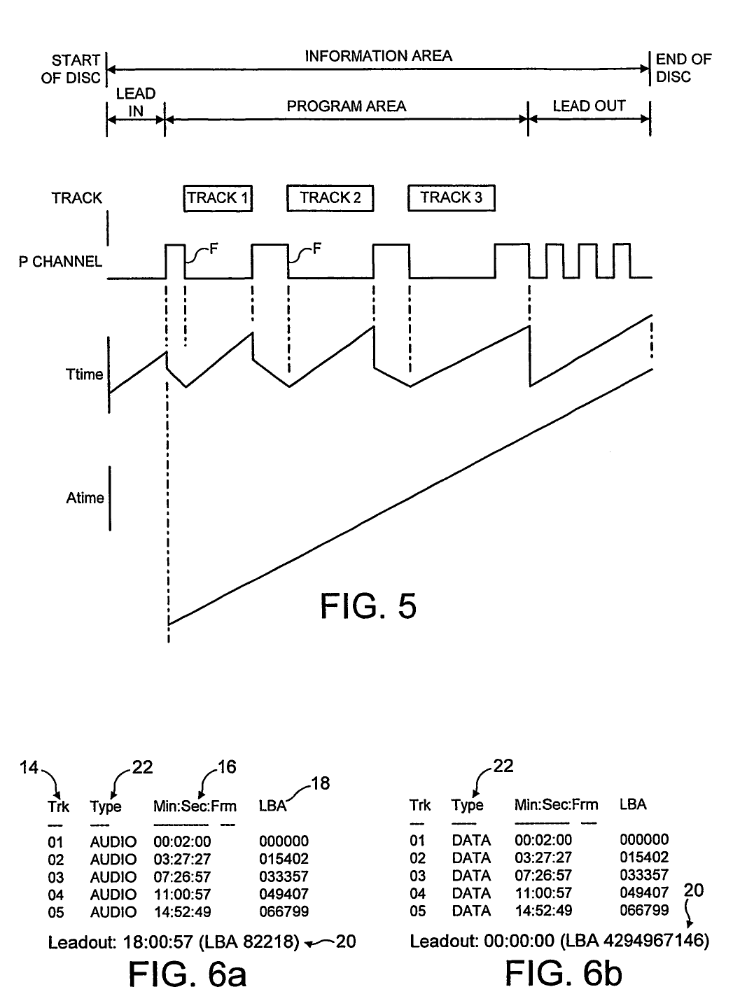

FIG. 5 shows graphically both Atime and Ttime on a compact disc,

FIG. 6a shows an example of the track definition, with the Table of Contents, of a CD-DA,

FIG. 6b shows the Table of Contents of the CD-DA of FIG. 6a when the disc has been copy protected,

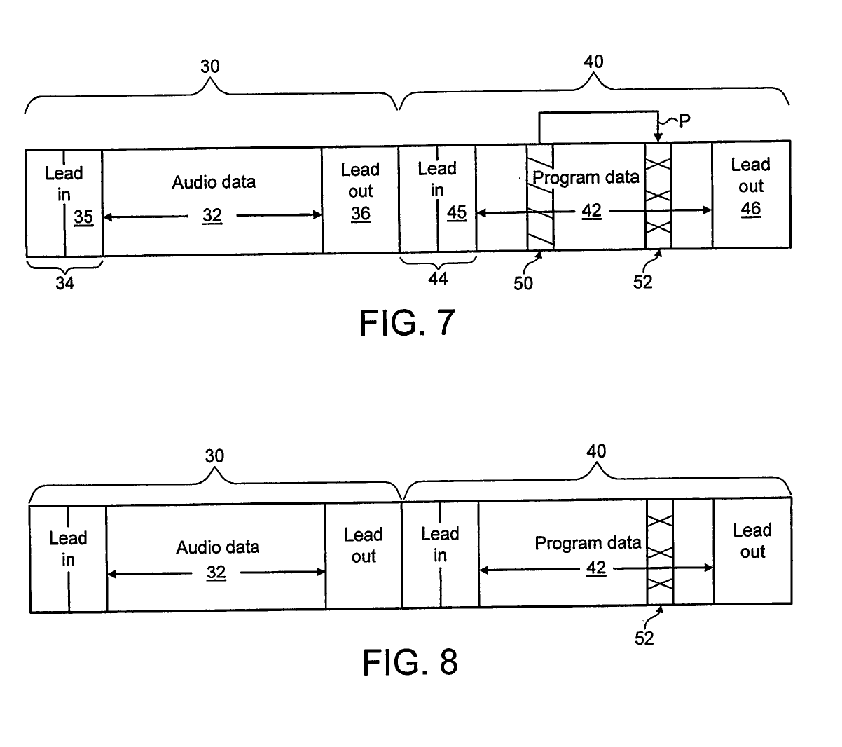

FIG. 7 shows schematically the information on an optical disc with multiple sessions,

FIG. 8 illustrates the corruption of the information on an optical disc by removal of the primary volume descriptor,

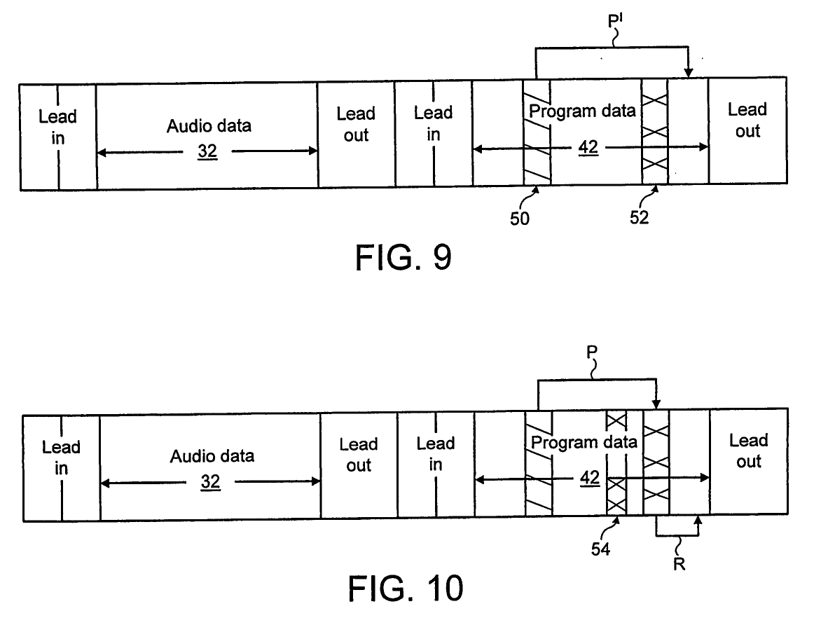

FIG. 9 illustrates interference with the information on an optical disc by corruption of the primary volume descriptor to render the addressing of a root directory incorrect, and

FIG. 10 illustrates interference with the information on an optical disc by corruption of the root directory to render addressing of sub-directories incorrect.

A digital audio compact disc (CD-DA), which carries music and is to be played on an audio player such as a conventional CD disc player, is made and recorded to a standard format known as the Red Book standards. As well as defining physical properties of the disc, such as its dimensions, and its optical properties, such as the laser wavelength, the Red Book also defines the signal format and the data encoding to be used.

As is well known, the Red Book standards ensure that any CD-DA produced to those standards will play on any audio player produced to those standards.

FIG. 1 shows schematically the spiral track 4 on a CD 6. This spiral track 4 on a CD-DA is divided into a Lead-In 8, a number of successive music or audio tracks as 10, and a Lead-Out 12. The Lead-In track 8 includes a Table of Contents (TOC) which identifies for the audio player the tracks to follow. The lead-Out 12 gives notice that the track 4 is to end.

An audio player always accesses the Lead-In track 8 on start up. The music tracks may then be played consecutively as the read head follows the track 4 from Lead-In to Lead-Out. Alternatively, the player navigates the read head to the beginning of each audio track as required.

Generally, compact disc players are programmed not to move the read head beyond the start of the Lead-Out track 12. This is to protect the read head.

To the naked eye, a CD-ROM looks exactly the same as a CD-DA and has the same spiral track divided into sectors. However, data readers, such as CD-ROM drives, are much more sophisticated and are enabled to read data, and process information, from each sector of the compact disc according to the nature of that data or information. A data reader can navigate by reading information from each sector whereby the read head can be driven to access any appropriate part of the spiral track 4 as required.

To ensure that any data reader can read any CD-ROM, the compact discs and readers are also made to standards known, in this case, as the Yellow Book standards. These Yellow Book standards incorporate, and extend, the Red Book standards. Hence, a data reader, such as a CD-ROM drive, can be controlled to playa CD-DA The ability of a data reader to access, extract, or otherwise read the data on a CD-DA provides a problem for the music industry. A user can use a CD-ROM drive to read the data from an audio disc, for example, into a computer file, and then that data can be copied. The increasing availability of recorders able to record onto compact discs means that individuals and organisations now have easy access to technology for making perfect copies of audio compact discs. This is of great concern to the music industry.

An audio player, be it a dedicated compact disc music player, or a more sophisticated CD-ROM drive when controlled to play an audio disc, only looks for and uses data encoded to Red Book standards. What is more, if there appears to be an inaccuracy in the data, an audio player will generally continue to play rather than trying to correct the error. For example, if the read head has navigated to the start of a track and commenced to play that track, the audio player will continue to play that track to its end, even if it becomes apparent that there is some error in the timing information. By contrast, a data reader is arranged to identify and correct errors.

As the data encoding on a CD-DA and on a CD-ROM is well known and in accordance with the appropriate standards, it is not necessary to describe it in detail herein.

Briefly, the data on a CD is encoded into frames by EFM (eight to fourteen modulation). FIG. 2 shows the format of a frame, and as is apparent therefrom, each frame has sync data, sub-code bits providing control and display symbols, data bits and parity bits. Each frame includes 24 bytes of data, which, for a CD-DA, is audio data.

There are 8 sub-code bits contained in every frame and designated as P, Q, R, S, T, U, V and W. Generally only the P and Q sub-code bits are used in the audio format. The standard requires that 98 of the frames of FIG. 2 are grouped into a sector, and the sub-code bits from the 98 frames are collected to form sub-code blocks. That is, each sub-code block is constructed a byte at a time from 98 successive frames. In this way, 8 different subchannels, P to W, are formed. These subchannels contain control data for the disc. The P- and Q-subchannels incorporate timing and navigation data for the tracks on the disc, and generally are the only subchannels utilised on an audio disc.

The data format for a Q-subchannel block assembled from 98 successive frames is indicated in FIG. 3. As is apparent, the start of the subchannel block is indicated by the appearance of sync patterns S0 and S1 as the first 2 symbols. The next data bits are control bits to define the contents of a track Thus, the control bits might identify audio content or data content. There then follows address information, ADR, which specifies one of four modes for the Q-data bits. 72 bits of Q-data succeed the address information, and then there are 16 CRC, or check, bits which are used for error detection on the control, address and Q-data bits.

FIG. 4 illustrates the data content of a Q-subchannel block in each of the four modes designated by the address information, ADR. In Mode 0, all of the Q-data has a value of zero. In Mode 2, the Q-data comprises a catalogue number for the disc, such as a bar code of the Universal Product Code. In addition, in Mode 2 the Aframe component of the time count from adjacent blocks is continued. Mode 3 is used to give ISR code for identifying each music track. In addition, and as is illustrated, in Mode 3 the absolute time count, Atime, is continued.

As indicated in FIG. 4, in Mode 1 the Q-data in each subchannel block contains program and time information for individual audio tracks and for the information area of the disc. As is illustrated, there is a different format for the Q-data for the Lead-In area to that within the program and Lead-Out areas. However, in both formats in Mode 1, the Q-data gives information as to the time along a track. The running time of a track is referred to as the Ttime, is in minutes, seconds and frames, and TMin, TSec and TFrame are all components of Ttime. In the program and Lead-Out areas, the Q-data additionally includes information about the absolute time, Atime, on the disc in minutes, seconds and frames, and AMin, ASec and AFrame are all components of Atime.

FIG. 5 shows graphically how Atime and Ttime vary across a disc. Atime is the absolute time across the disc and starts at zero at the beginning of the program area. Ttime is the running time within each track and thus starts at zero at the beginning of each track. Thus, and as illustrated in FIG. 5, Atime increases monotonically across the disc whilst Ttime increases along each individual track As is also illustrated in FIG. 5, the P-subchannel includes flags F which each indicate the start of a respective track. The P-subchannel flags also designate the Lead-Out area.

As indicated in FIG. 4, in Mode 1 each Q-subchannel block contains the next consecutive values for Atime and Ttime. When an audio player is to play an audio track, the head is navigated to the start of the track. The navigation may be by way of the Atime, the Ttime, and/or the P-subchannel flags, or by some combination thereof. In general, once an audio player has started playing a track, it will continue. Playing of the track is not generally stopped if any data errors are located, and thus the audio player effectively ignores any data errors which arise. Thus, if an audio player can be reliably navigated to the start of a track, it can be expected to provide a continuous audio output from that track without problem.

As set out above, the Mode 1 Q-data in the Lead-In area provides the TOC. Part of a typical TOC is set out in table form in FIG. 6a. It will be seen therefrom that each track, at 14, is given, at 16, a start address in time and in sectors from the end of the Lead-In. Each track also has a logical block address (LBA) 18 which is calculated from the Atime and provides an address for the start of the track on the disc. The TOC of an audio disc also identifies the Atime from the start of the program area to the start of the Lead-Out as indicated at 20. However, audio players do not generally read or use the Lead-Out time from the TOC.

FIG. 6b shows in table form part of the TOC from FIG. 6a after it has been altered to copy protect the disc by a method as described in WO 00/74053. Specifically, it will be seen that, at 20, the Atime from the start of the disc program area to Lead-Out has been set to zero indicating that the Lead-Out is at the commencement of the pregap of the first audio track. A data reader, therefore, accessing the disc 6 will read from the Lead-In information signifying that the disc does not have a program area and that the Lead-In is directly followed by the Lead-Out. The data reader will refuse to move the read head beyond the start of the audio track because it believes that the first track starts within the Lead-Out. A data reader, therefore, will be unable to read or play the disc with the TOC of FIG. 6b.

Again as described in WO 00/74053, the TOC of FIG. 6b has been altered in a second way which also prevents proper use by a data reader of the information on the disc. In this respect, and as is apparent from FIGS. 6a and 6b, the tracks on the audio disc are all audio tracks as noted at 22. In the TOC of FIG. 6b these tracks have been erroneously identified as data tracks. Thus, even if the data reader is manipulated to ignore the false Lead-Out information in the TOC, it is told that each of the following tracks contains digital data, rather than analog audio. Any reading of those tracks is therefore confused as the player tries to read the data but cannot find the appropriate SYNC or sector headers. Errors therefore result and the reading is unsatisfactory.

The types of data carried on optical discs, and the data formats, have developed since the original CD-DAs were first commercially produced. For example, the information carried by optical discs may now comprise not only audio, numerical, or written data, but video, graphics, programs, computer and other data. Furthermore, optical discs may no longer include just a single information session as shown in FIG. 1 in which information extends between a Lead-In 8 and a Lead-Out 12. FIG. 7 illustrates a format having multiple sessions in which a first session generally indicated at 30 has a first program area 32 between a respective Lead-In 34 and Lead-Out 36, and a subsequent session 40 has its own program area 42 similarly arranged between a respective Lead-In 44 and a Lead-Out 46. Each Lead-In 34, 44 will generally include a TOC indicated at 35 and 45.

FIG. 7 specifically illustrates a multiple session disc in which the first session has information in the form of audio data, such that the session 30 is an audio session. The subsequent session 40 is a data session having non-audio data in its program area 42. As described above, an audio player faced with a disc having multiple sessions as shown in FIG. 7 will generally access the disc by way of the first Lead-In 34, play the audio in the program area 32 and stop when it reaches the Lead-Out 36. A conventional audio player will therefore be generally unaware of the existence of the second session 40. This leads to a method of protecting the data in the program area 32 from being read and copied by a data reader as described below.

In this respect, a data reader generally initially scans the whole of the information area of a disc to establish the sessions thereon. Where there are multiple sessions, a data reader will generally access the Lead-In 34, 44, or at least the Table of Contents 35, 45 of each session. Thus, it has been proposed to put erroneous data in a Lead-In, as 44, of a second or subsequent session, as 40, which relates to the program area 32 of the first session 30. This erroneous data can be used to copy protect the program area 32 against a data reader whilst having no impact on the performance of an audio player. Thus, if in the Lead-In area 44 information in the program area 32 is identified as data, a data reader will not be able to read the audio data in the program area 32.

Thus, it is possible to copy protect a CD-DA by, for example, providing a dummy second session 40 on the disc which has erroneous information relating to the first, audio, session 30. The erroneous information may identify the tracks of the first session as data whereby the data reader is unable to read the audio data in the program area 32 because it appears to be in an incorrect format.

Instead of making the second session 40 a dummy session, it may alternatively be provided as a data session having additional material accessible, for example, only to a data reader. Thus, the second data session 40 may include video data relating to the audio tracks of the first session 30. This enables the user of a data reader to be given added value from what appears to be a CD-DA, but to be prevented from copying the audio data.

As the amount of information which can be recorded on an optical disc, and particularly on a CD-ROM, has increased and as the type and nature of the information has similarly increased, it became necessary to develop standards for the structure of the information recorded on optical discs. One such standard is the ISO 9660 standard which sets down the arrangement of information on an optical disc and requires the provision of standard indexes to describe the contents of a data session.

Briefly, the information in the data session or sessions is arranged in files. The interrelationship of each file with other files, and the location and attributes of the files are recorded in directories. These directories are arranged in a hierarchical relationship with a root directory and a plurality of other sub-directories. The files and directories together constitute a volume which additionally includes volume descriptors, directory descriptors and file descriptors. The descriptors contain descriptive information about the corresponding volume, directories and files and also contain information as to the structure of the volume. To enable all of the information in the volume to be accessed, each directory is identified in at least one other directory, and the root directory is identified either in a primary volume descriptor (PVD) or in a supplementary volume descriptor (SVD).

The ISO 9660 standard is well known and need not be further identified herein. Full details of the technically identical ECMA-119 are available at www.ecma.ch.

The standard requires that the primary volume descriptor (PVD) 50 occurs after the standard Lead-In 44 of a data session as 40. Thus, on a multiple session disc as shown in FIG. 7, which is provided with a first, substantially standard audio session 30, and a second, data session 40, the PVD 50 is provided immediately after sector 15 in the program area 42 of the data session 40, that is, there are 16 sectors from the commencement of the program area 42 to the PVD 50.

When a data reader accesses an optical disc which has data arranged thereon in accordance with ISO 9660, it will access and read the descriptors to identify the information on the disc and its structure. Thus, to access any area of the optical disc, a data reader will access the descriptors and search through the information therein to find the data files in which it is interested. It will be immediately apparent that if the information in the descriptors is rendered incorrect or is corrupted, a data reader will have grave difficulties in accessing the information on the disc. For example, where the operating system of a data reader, in attempting to access data content, encounters abnormal values it may cause the data reader to malfunction. The operating system may attempt to re-read the sectors identified by the corrupted descriptors and/or it may subject the information to its error handling systems. However, it is unlikely that a data reader operating system will be able to read audio data correctly. With erroneous descriptors, therefore, the best a data reader is likely to achieve is the copying of the data in corrupted fashion such that access to the audio data is not enabled on a resulting copy. Other data readers may simply “crash”.

The incorrect data introduced into the descriptors may be one or more of a number of errors. One way of corrupting or rendering the data of one or more descriptors incorrect would be to replace their contents with zeros or to otherwise alter their normal values. For example, the values could be replaced by random numbers. Additionally and/or alternatively, data values of the volume may be replaced with values which cause DSV problems, for example, as described in PCT/GB01/03364.

Additionally and/or alternatively, parts of the volume may be encrypted. The encrypted data would act in the same way as other incorrect data and prevent access to the data described thereby, but would give the opportunity to offer decryption software to a user to enable reading of the disc, for example, in return for a license fee.

The PVD 50 will contain information such as the title of the disc, and general information as to the location of the directories. As set out above, the PVD 50 identifies the root directory 52, and, as is shown in FIG. 7, this may be by way of a pointer P which points to the root directory 52. Thus, the PVD provides the overall control data enabling access to the information on the disc, and in preferred embodiments, it is the data in PVD 50 which is rendered incorrect.

Thus, and for example, all of the data in the PVD 50 may be set to zero.

FIG. 8 shows an alternative embodiment in which the PVD 50 has been removed.

In the embodiment shown in FIG. 9, the PVD 50 has been corrupted so that the pointer P¹ no longer points to the root directory 52, but to a different part of the volume. Therefore, the root directory 52 is not accessed.

It is alternatively possible to keep a valid PVD, but to make changes to the volume so that, for example, the directory structure differs from its PVD. In the embodiment shown in FIG. 10, the root directory 52 has been corrupted so that, for example, its pointer R no longer points to a sub-directory 54. In this case, in fact, the pointer R does not point to any valid sub-directory.

It will be appreciated that other changes may be made to the volume either to render its structure invalid, or to cause selected descriptors to describe the volume structure or content inaccurately. Specifically one or more descriptors other than the PVD may be corrupted or removed, or the structures described by the descriptors may be changed.

There are standards other than ISO 9660 which exist now, such as Joliet and UDF, and clearly further standards may exist in the future for conforming the structures with which information may be encoded onto an optical disc. It will be appreciated that the present invention is applicable to any such standards whether or not they are in existence now. In this respect, the invention requires only that appropriate descriptive data be rendered incorrect or inaccurate to provide copy protection for any data described by that incorrect or inaccurate descriptive data. Thus, as described above, data in the primary volume descriptor might be rendered incorrect. Additionally and/or alternatively, data in a supplementary volume descriptor may be rendered incorrect. Corruption may also take place at different levels in the file structure information, for example, in file allocation tables or in any pointers associated with the addresses of sectors.

As described above, embodiments of the invention may be used to protect CD-DAs. This may be by adding a dummy session to an audio session and providing in that dummy session descriptive data relating to the audio session which has been rendered incorrect. Alternatively, and as discussed above, the further sessions added may be data sessions including useful and usable information which may be accessible or may be copy protected at the publisher's choice.

However, it will be appreciated that the techniques described herein can have broader application than the protection of audio data only against copying by way of data readers. Thus, and as described, the techniques may be used to ensure that only licensed purchasers are able to access or copy data from a CD-ROM, for example.

It will be appreciated that further modifications and variations to the invention as described and illustrated may be made within the scope of this application.

1. A method of controlling access to information on an optical disc, the optical disc carrying information and control data, and the control data being arranged to facilitate access to the information, wherein access to selected information is controlled by interfering with control data describing said selected information, the interference with the control data including one or more of removing the control data, corrupting the control data, rendering the control data incorrect and rendering the control data inaccurate.

2. A method according to claim 1, wherein the interference applied to the control data is arranged to copy protect the information on an optical disc.

3. A method according to claim 1, wherein the interference applied to the control data is arranged to enable access to any information on an optical disc where that access is licensed.

4. A method according to claim 1, wherein the information is arranged on the optical disc in at least two separate sessions, respective control data being associated with each session, access to the selected information in a first session being controlled by interfering with control data which is in a second session and which describes said selected information.

5. A method according to claim 1, wherein the control data to which the interference is applied is descriptive data providing one or more of a description as to the nature of the information, a description as to the location of the information on the disc, a description as to the structure of the information on the disc, and a description as to how the information should be accessed.

6. A method according to claim 5, wherein the control data to which the interference is applied is provided in the Lead-In to a data session.

7. A method according to claim 6, wherein the control data is in the Table of Contents (TOC).

8. A method according to claim 5, wherein the control data to which the interference is applied is provided in one or more descriptors for the information.

9. A method according to claim 8, wherein said control data is in a primary volume descriptor.

10. A method according to claim 8, wherein said control data is in a secondary volume descriptor.

11. A method according to claim 8, wherein said control data is in one or more directories.

12. A method according to claim 5, where the control data to which the interference is applied is address information.

13. A method according to claim 5, wherein the control data to which the interference is applied is navigation or timing data.

14. A method according to claim 1, wherein the control data is removed.

15. A method according to claim 5, wherein the control data is removed.

16. A method according to claim 14, wherein the removed control data is a primary volume descriptor.

17. A method according to claim 1, wherein the control data is corrupted.

18. A method according to claim 5, wherein the control data is corrupted.

19. A method according to claim 17, wherein the control data is corrupted by replacing values thereof with different values.

20. A method according to claim 17, wherein the control data is corrupted by replacing values thereof with different values, and wherein the replacement values are all zeros or random numbers.

21. A method according to claim 17, wherein the control data is corrupted by replacing values thereof with different values, and wherein the replacement values are chosen to cause DSV problems.

22. A method according to claim 17, wherein the control data is encrypted or scrambled.

23. A method according to claim 1, wherein the control data is rendered incorrect or inaccurate.

24. A method according to claim 23, wherein the control data is rendered incorrect or inaccurate by interfering with one or more of the nature of the information, the location of the information, the structure of the information, and addresses for the information.

25. A method of controlling access to information on an optical disc, the optical disc carrying the information and control data, and the control data being arranged to facilitate access to the information, wherein the information is arranged on the optical disc in at least two separate sessions, respective control data being associated with each session, and wherein access to the information in a first session is controlled by incorporating incorrect or inaccurate values in control data in a second session.

26. A method according to claim 25, wherein the incorrect or inaccurate values are incorporated into the control data in the second session describe the information in the first session to which access is to be controlled.

27. A method according to claim 26, where the information in the first session is audio data, and the second session is a data session, and wherein the method renders said audio data unreadable to a data reader by including in the second data session control data which incorrectly identifies audio files in the first session as data files.

28. A method according to claim 26, wherein the control data incorporating incorrect or inaccurate values is arranged to render the optical disc unplayable unless appropriate means are provided to correct the incorrect or inaccurate values.

29. An optical disc carrying information and control data, and carrying means to control access to the information thereon, wherein the control data is arranged to facilitate access to the information, and wherein, to control access to selected information, control data describing that selected information has been interfered with, the interference to the control data including one or more of removing the control data, corrupting the control data, rendering the control data incorrect or rendering the control data inaccurate.

30. An optical disc according to claim 29, wherein the interference which was applied to the control data is arranged to copy protect the information on the disc.

31. An optical disc according to claim 29, wherein the interference which was applied to the control data is arranged to enable access to selected information on the disc only where that access is licensed.

32. An optical disc according to claim 29, wherein information is arranged on the disc in at least two separate sessions, respective control data being associated with each session, and access to the selected information in a first session being controlled by providing that control data, which is in a second session, and which describes said selected information, has been interfered with.

33. An optical disc according to claim 29, wherein the control data to which the interference has been applied is descriptive data which provides one or more of a description as to the nature of the information, a description as to the location of the information on the disc, a description as to the data structure of the information on the disc, and a description as to how the information is to be accessed.

34. An optical disc according to claim 33, wherein the control data is provided in the Lead-In to a data session.

35. An optical disc according to claim 34, wherein the control data to which interference has been applied is in the Table of Contents (TOC).

36. An optical disc according to claim 29, wherein the control data to which interference has been applied is provided in one or more descriptors for the information.

37. An optical disc according to claim 36, wherein the control data is in a primary volume descriptor.

38. An optical disc according to claim 36, wherein the control data is in a secondary volume descriptor.

39. An optical disc according to claim 36, wherein the control data is in one or more directories.

40. An optical disc according to claim 36, wherein the control data to which interference has been applied is address information.

41. An optical disc according to claim 36, wherein the control data to which interference has been applied is navigation or timing data.

42. An optical disc according to claim 29, wherein the control data has been removed.

43. An optical disc according to claim 42, wherein the removed control data was a primary volume descriptor.

44. An optical disc according to claim 29, wherein the control data has been corrupted.

45. An optical disc according to claim 44, wherein the control data was corrupted by replacing values thereof with different values.

46. An optical disc according to claim 45, wherein the replacement values are all zeros or random numbers.

47. An optical disc according to claim 45, wherein the replacement values were chosen to cause DSV problems.

48. An optical disc according to claim 45, wherein the control data has been encrypted or scrambled.

49. An optical disc according to claim 29, wherein the control data has been rendered incorrect or inaccurate.

50. An optical disc according to claim 49, wherein the control data has been rendered incorrect or inaccurate by interfering with one or more of the nature of the information, the location of the information, the structure of the information, and addresses for the information.

51. An optical disc carrying information and control data, and carrying means to control access to information thereon, the control data being arranged to facilitate access to the information, wherein the information is arranged on the disc in at least two separate sessions, respective control data being associated with each session, and wherein access to the information in a first session is controlled by control data in a second session, and incorrect or inaccurate values have been incorporated into said control data in said second session.

52. An optical disc according to claim 51, wherein the incorrect or inaccurate values have been incorporated in control data which is in the second session and which describes the information in the first session to which access is to be controlled.

53. A volume of information for application to a data carrying disc, the information being arranged in files, the attributes and locations of the files being recorded in directories, and the volume being incorporated by the files and directories and by descriptors containing descriptive information about the volume, directories and files, the volume of information having been altered to control or prevent access to selected information, the alteration being the interference with one or more of the descriptors, the interference of the descriptors including one or more of removing at least one descriptor, corrupting at least one descriptor, rendering at least one descriptor incorrect and rendering at least one descriptor inaccurate.

54. A volume according to claim 53, wherein a primary volume descriptor is interfered with.

55. A volume according to claim 53, wherein a secondary volume descriptor is interfered with.

56. A volume according to claim 53, wherein the alteration is the interference with one or more directories, the interference of the directories including one or more of corrupting data of the directories, removing data from the directories, or rendering data in the directories incorrect or inaccurate.

57. A volume according to claim 53, wherein the alteration is the interference with data in address information, the interference including one or more of corrupting data in address information, removing data in address information, rendering data in address information incorrect and rendering data in address information inaccurate.

58. A volume according to claim 53, wherein a primary volume descriptor is removed.

59. A volume according to claim 53, wherein a pointer of a primary volume descriptor to a directory is removed.

60. A volume according to claim 59, wherein the directories are arranged in a hierarchical structure having a root directory and other sub-directories, and wherein the removed pointer had accessed the root directory.

61. A volume according to claim 53, wherein the data in at least one descriptor is corrupted.

62. A volume according to claim 61, wherein the data is corrupted by replacing values thereof with different values.

63. A volume according to claim 62, wherein the replacement values are all zeros or random numbers.

64. A volume according to claim 62, wherein the replacement values are chosen to cause DSV problems.

65. A volume according to claim 53, wherein the descriptors are altered by interfering with one or more of the nature of the information, the location of the information, the structure of the information, and addresses for the information.
